(19) United States
(12) Patent Application Publication
(10) Pub. No.: US 2012/0209453 A1
(43) Pub. Date: Aug. 16, 2012

(54) IN-VEHICLE DEVICE, INFORMATION PROCESSING CENTER, AND DRIVING EVALUATION SYSTEM

(75) Inventors: Hiroaki Sekiyama, Setagaya-ku (JP); Shojiro Takeuchi, Shinagawa-ku (JP); Satomi Yoshioka, Yokohama-shi (JP)

(73) Assignee: TOYOTA JIDOSHA KABUSHIKI KAISHA, Toyota-shi (JP)

(21) Appl. No.: 13/500,768

(22) PCT Filed: Oct. 6, 2010
(86) PCT No.: PCT/JP2010/067546

§ 371 Date: Apr. 6, 2012

(30) Foreign Application Priority Data
Oct. 9, 2009 (JP) 2009-235625

(51) Int. Cl. G06F 7/00

(52) U.S. Cl. 701/1

(57) ABSTRACT

A check point calculation unit evaluates the driving of a driver in a travel segment where a host vehicle has traveled and extracts a check point where the driving evaluation does not meet a predetermined evaluation standard, thereby obtaining data representing a point in the travel segment where the driving evaluation is lowered. An advice generation unit provides maneuver support to the driver on the basis of the check point. When there is the check point in the traveling direction host vehicle, the advice generation unit provides maneuver support at the check point such that the driving evaluation by the check point calculation unit meets a predetermined evaluation standard, thereby improving the driving evaluation at the check point where the driving evaluation is low and improving the driving evaluation as a whole.

### TECHNICAL FIELD

The present invention relates to an in-vehicle device, an information processing center, and a driving evaluation system for evaluating the driving of a driver.

### BACKGROUND ART

A technique has been suggested which evaluates the driving of a driver of a vehicle and enhances awareness of the driver of safe driving or fuel-efficient driving (hereinafter, also referred to as economical driving). For example, Patent Literature 1 describes a device which detects whether or not the vehicle is in an idling stop state or an energy-saving traveling state from the engine speed or the like of the vehicle measured by an in-vehicle device. In this device, if each state is detected, the duration time of the corresponding state is measured. This device makes an evaluation according to the time spent by a user on economical driving on the basis of the measurement result of the duration time.

### CITATION LIST

### Patent Literature

[Patent Literature 1] Japanese Unexamined Patent Application Publication No. 2005-16443

### SUMMARY OF INVENTION

### Technical Problem

In the above-described technique, for example, a driver can obtain the driving evaluation for each run of a vehicle. However, in the above-described technique, it is unclear which of various driving operations by the driver during a single run of the vehicle affects the evaluation. Accordingly, even if the driving evaluation is provided, it is difficult for the driver to improve a driving operation based on the driving evaluation during next driving.

The invention has been finalized in consideration of the above-described situation, and an object of the invention is to provide an in-vehicle device, an information processing center, and a driving evaluation system which make it easier for a driver to improve a driving operation based on driving evaluation.

### Solution to Problem

An in-vehicle device according to the invention includes an evaluation unit which evaluates the driving of a driver of a host vehicle in a predetermined travel segment that the host vehicle has traveled, and a driving support unit which supports a driving operation of the driver of the host vehicle at a caution point in the travel segment where the driving evaluation by the evaluation unit does not meet a predetermined evaluation standard. When there is the caution point in the traveling direction of the host vehicle, the driving support unit supports the driving operation of the driver of the host vehicle such that the driving evaluation by the evaluation unit meets the predetermined evaluation standard at the caution point.

With this configuration, the evaluation unit evaluates the driving of the driver of the host vehicle in the predetermined travel segment where the host vehicle has traveled, and the driving support unit supports the driving operation of the driver of the host vehicle at the caution point in the travel segment where the driving evaluation by the evaluation unit does not meet the predetermined evaluation standard. Thus, it is possible to obtain data representing a point in the travel segment where evaluation for a driving operation is lowered, making it possible for the driver to improve driving focusing on a point in the travel segment where driving evaluation is low. For this reason, it becomes easier for the driver to improve a driving operation based on the driving evaluation. When there is the caution point in the traveling direction of the host vehicle, the driving support unit supports the driving operation of the driver of the host vehicle such that the driving evaluation by the evaluation unit meets the predetermined evaluation standard at the caution point. Thus, it becomes possible to improve the driving evaluation at a caution point where the driving evaluation is low and to improve the driving evaluation as a whole.

In this case, when there is an estimated caution point where the difference in traveling conditions with respect to the caution point is within a predetermined threshold value, the driving support unit may support the driving operation of the driver of the host vehicle on the basis of the estimated caution point.

With this configuration, when there is an estimated caution point where the difference in traveling conditions with respect to the caution point is within a predetermined threshold value, the driving support unit supports the driving operation of the driver of the host vehicle on the basis of the estimated caution point. For this reason, in regard to a point where the host vehicle has not yet actually traveled which is defined as a caution point where the driving evaluation is likely to be lowered, it becomes possible for the driver to improve the driving operation.

An in-vehicle device according to the invention includes an evaluation unit which evaluates the driving of a driver of a host vehicle in a predetermined travel segment that the host vehicle has traveled, and a driving support unit which supports a driving operation of the driver of the host vehicle at a caution point in the travel segment where the driving evaluation by the evaluation unit does not meet a predetermined evaluation standard. When there is an estimated caution point where the difference in traveling conditions with respect to the caution point is within a predetermined threshold value, the driving support unit supports the driving operation of the driver of the host vehicle on the basis of the estimated caution point.

With this configuration, the evaluation unit evaluates the driving of the driver of the host vehicle in the predetermined travel segment where the host vehicle has traveled, and the driving support unit supports the driving operation of the driver of the host vehicle at the caution point in the travel segment where the driving evaluation by the evaluation unit does not meet the predetermined evaluation standard. Thus, it is possible to obtain data representing a point in the travel segment where evaluation for a driving operation is lowered, making it possible for the driver to improve driving focusing on a point in the travel segment where the driving evaluation is low. For this reason, it becomes easier for the driver to improve a driving operation based on the driving evaluation. When there is an estimated caution point where the difference in traveling conditions with respect to the caution point is within a predetermined threshold value, the driving support unit supports the driving operation of the driver of the host vehicle on the basis of the estimated caution point. For this reason, in regard to a point where the host vehicle has not yet actually traveled which is defined as a caution point where the driving evaluation is likely to be lowered, it becomes possible for the driver to improve the driving operation.

In this case, when there is the caution point in the traveling direction of the host vehicle, the driving support unit may support the driving operation of the driver of the host vehicle such that the driving evaluation by the evaluation unit meets the predetermined evaluation standard at the caution point.

With this configuration, when there is the caution point in the traveling direction of the host vehicle, the driving support unit supports the driving operation of the driver of the host vehicle such that the driving evaluation by the evaluation unit meets the predetermined evaluation standard at the caution point. Thus, it becomes possible to improve the driving evaluation at a caution point where the driving evaluation is low and to improve the driving evaluation as a whole.

When there is a statistical caution point where driving evaluation for drivers of an unspecified number of other vehicles does not meet the predetermined evaluation standard, the driving support unit may support the driving operation of the driver of the host vehicle on the basis of the statistical caution point.

With this configuration, when there is a statistical caution point where driving evaluation for drivers of an unspecified number of other vehicles does not meet the predetermined evaluation standard, the driving support unit supports the driving operation of the driver of the host vehicle on the basis of the statistical caution point. For this reason, in regard to a point where the host vehicle has actually traveled which is a point where driving evaluation for an unspecified number of drivers is low and is thus defined as a point where more attention is paid to the driving operation, it becomes possible for the driver to improve the driving operation. Alternatively, in regard to a point where the host vehicle has not yet actually traveled which is a point where driving evaluation for unspecified number of drivers is low and is thus defined as a caution point where the driving evaluation for the driver is likely to be lowered, it becomes possible for the driver to improve the driving operation.

The driving support unit may highlight the caution point on a display screen to support the driving operation of the driver of the host vehicle.

With this configuration, the driving support unit highlights the caution point on a display screen to support the driving operation of the driver of the host vehicle. For this reason, it becomes easy for the driver to visually recognize a caution point.

The driving support unit may perform traveling control for correcting the driving operation of the driver of the host vehicle to support the driving operation of the driver of the host vehicle.

With this configuration, the driving support unit performs traveling control for correcting the driving operation of the driver of the host vehicle to support the driving operation of the driver of the host vehicle. For this reason, even if the driving operation of the driver of the host vehicle is not appropriate, it becomes possible to improve the driving evaluation.

An information processing center according to the invention includes an evaluation unit which evaluates the driving of a driver of one host vehicle in a predetermined travel segment that one vehicle has traveled, and a caution point extraction unit which extracts a caution point in the travel segment where the driving evaluation by the evaluation unit does not meet a predetermined evaluation standard. The caution point extraction unit extracts a point where the difference in traveling conditions with respect to the caution point is within a predetermined threshold value as an estimated caution point.

In this case, the evaluation unit may evaluate the driving of drivers of an unspecified number of other vehicles in a predetermined travel segment that the unspecified number of other vehicles have traveled, and the caution point extraction unit may extract a point where the driving evaluation by the evaluation unit does not meet a predetermined evaluation standard as a statistical caution point.

The information processing center may further include a distribution unit which distributes information including the caution point to the one vehicle.

A driving evaluation system according to the invention includes an evaluation unit which evaluates the driving of a driver of one vehicle in a predetermined travel segment that the one vehicle has traveled, and a driving support unit which supports a driving operation of the driver of the one vehicle at a caution point in the travel segment where the driving evaluation by the evaluation unit does not meet a predetermined evaluation standard. When there is the caution point in the traveling direction of the one vehicle, the driving support unit supports the driving operation of the driver of the one vehicle such that the driving evaluation by the evaluation unit meets the predetermined evaluation standard at the caution point.

In this case, when there is an estimated caution point where the difference in traveling conditions with respect to the caution point is within a predetermined threshold value, the driving support unit may support the driving operation of the driver of the one vehicle on the basis of the estimated caution point.

A driving evaluation system according to the invention includes an evaluation unit which evaluates the driving of a driver of one vehicle in a predetermined travel segment that the one vehicle has traveled, and a driving support unit which supports a driving operation of the driver of the one vehicle at a caution point in the travel segment where the driving evaluation by the evaluation unit does not meet a predetermined evaluation standard. When there is an estimated caution point where the difference in traveling conditions with respect to the caution point is within a predetermined threshold value, the driving support unit supports the driving operation of the driver of the one vehicle on the basis of the estimated caution point.

In this case, it is preferable that, when there is the caution point in the traveling direction of the one vehicle, the driving support unit supports the driving operation of the driver of the one vehicle such that the driving evaluation by the evaluation unit meets the predetermined evaluation standard at the caution point.

The evaluation unit may evaluate the driving of drivers of an unspecified number of other vehicles in a predetermined travel segment that the unspecified number of other vehicles have traveled, and the driving support unit may support the driving operation of the driver of the one vehicle on the basis of a statistical caution point where the driving evaluation by the evaluation unit does not meet a predetermined evaluation standard.

It is preferable that, when there is the caution point in the traveling direction of the one vehicle, the driving support unit supports the driving operation of the driver of the one vehicle such that the driving evaluation by the evaluation unit meets the predetermined evaluation standard at the caution point.

The driving support unit may highlight the caution point on a display screen to support the driving operation of the driver of the one vehicle.

### Advantageous Effects of Invention

According to the in-vehicle device, the information processing center, and the driving evaluation system of the invention, it becomes easier for the driver to improve the driving operation based on the driving evaluation.

### BRIEF DESCRIPTION OF DRAWINGS

FIG. 1 is a block diagram showing the configuration of a driving evaluation system according to an embodiment.

FIG. 2 is a flowchart showing the outline of the operation of the driving evaluation system according to the embodiment.

FIG. 3 is a flowchart showing an operation to set a check point.

FIG. 4 shows a display screen which displays a traveling route on certain date, day of week, and time.

FIG. 5 is a graph showing an accelerator opening for each position on the traveling route of FIG. 4.

FIG. 6 is a graph showing the degree of economical driving for each position on the traveling route of FIG. 4.

FIG. 7 is a flowchart showing an operation to provide a driver with advice.

FIG. 8 shows a display screen which displays a check point on the traveling route of FIG. 4.

### DESCRIPTION OF EMBODIMENTS

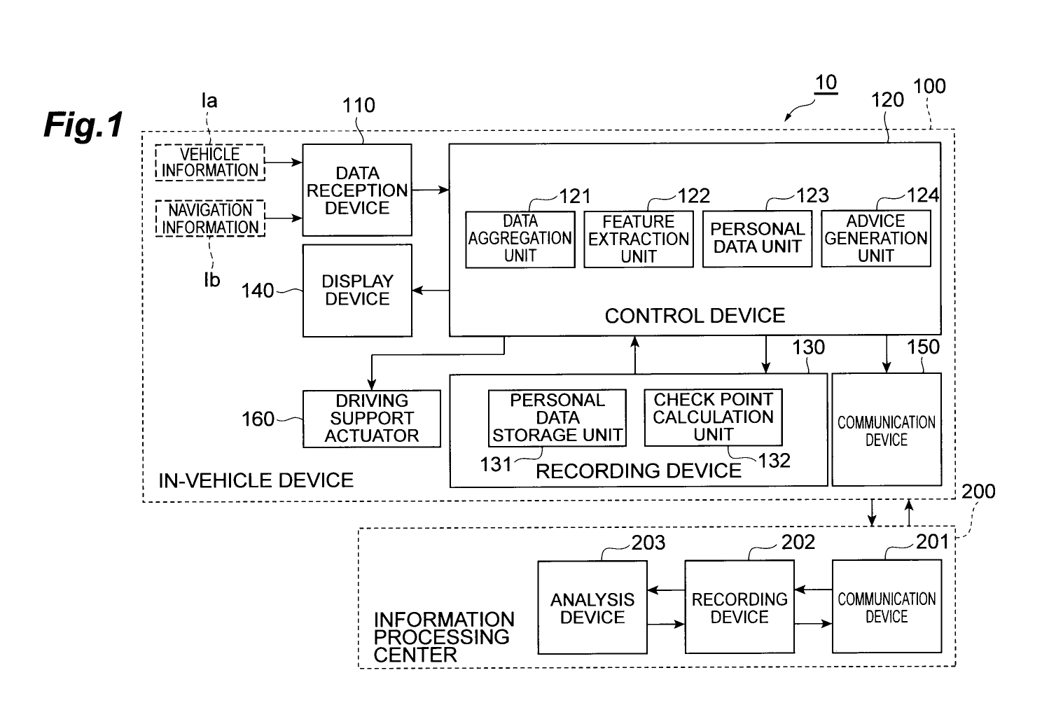

Hereinafter, an in-vehicle device, an information processing center, and a driving evaluation system according to an embodiment of the invention will be described with reference to the drawings. As shown in FIG. 1, a driving evaluation system 10 of this embodiment includes an in-vehicle device 100 and an information processing center 200. The driving evaluation system of this embodiment is a system which is configured to evaluate the degree of attainment of economical driving with respect to various driving operations of a driver of a host vehicle.

The in-vehicle device 100 is a device which is mounted in a vehicle, which uses the driving evaluation system 10 of this embodiment. The in-vehicle device 100 has a data reception device 110, a control device 120, a recording device 130, a display device 140, a communication device 150, and a driving support actuator 160.

The data reception device 110 is configured to acquire vehicle information 1 a for analyzing a driving operation of a driver from information or the like transmitted from sensors provided in the vehicle or sensors provided on the road side. The vehicle information 1 a includes an accelerator opening, a vehicle speed, and acceleration. The data reception device 110 is configured to acquire navigation information 1b relating to the traveling conditions of the host vehicle by a navigation system provided in the vehicle, an optical beacon transmitter provided on the road side, or the like. The navigation information 1b includes a traveling path, a road shape, a road inclination, date, day of week, and time, and the like.

The control device 120 is configured to control a method of extracting a feature of a driving operation of the driver or providing advice to the driver. The control device 120 includes a data aggregation unit 121, a feature extraction unit 122, a personal data unit 123, and an advice generation unit 124.

The data aggregation unit 121 is configured to aggregate the vehicle information 1 a and the navigation information 1b input from the data reception device 110 for a subsequent process. The feature extraction unit 122 is configured to extract a feature with a traveling condition from the aggregated vehicle information 1a and navigation information 1b. The personal data unit 123 is configured to record variations in a feature of the driving of the driver of the host vehicle in terms of segments as a traveling result. The advice generation unit 124 is configured to generate the content of advice to the driver and to determine the timing at which advice is provided.

The recording device 130 is configured to record various kinds of information. The recording device 130 includes a personal data storage unit 131 and a check point calculation unit 132. The personal data storage unit 131 is configured to store personal data relating to a driving operation for each driver which drives the host vehicle. The check point calculation unit 132 is configured to analyze personal data of the personal data storage unit 131 to set a check point where the evaluation of a driving operation does not meet a predetermined evaluation standard.

The display device 140 is configured to provide the driver with advice about a driving operation of the driver. Specifically, the display device 140 is a display, a speaker, or the like.

The communication device 150 is configured to control communication with the information processing center 200. The driving support actuator 160 is configured to correct a driving operation of the driver. Examples of the correction include switching between traveling by an internal combustion engine and traveling by an electric motor, an increase in braking force, correction of the shift position of a transmission, and the like.

The information processing center 200 is configured to receive and analyze data from the in-vehicle device 100 of the host vehicle or each of other vehicles, and to transmit the analysis result to the in-vehicle device 100 of the host vehicle or each of other vehicles. The information processing center 200 has a communication device 201, a recording device 202, and an analysis device 203.

The communication device 201 is configured to control communication with the in-vehicle device 100. The recording device 202 is configured to record personal data including a check point transmitted from the in-vehicle device 100 for each driver. The analysis device 203 is configured to analyze information and to extract and record a specific point during economical driving.

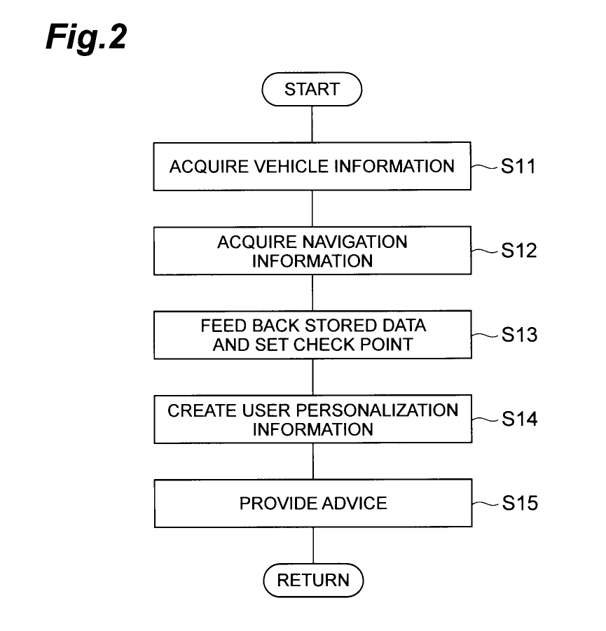

Hereinafter, the operation of the driving evaluation system 10 of this embodiment will be described. First, the outline of the operation will be described. As shown in FIG. 2, vehicle information Ia is acquired (S11). Navigation information Ib is acquired (S12). Stored data is fed back and a check point is set (S13). User personalization information individualized for each user (driver) is created (S14). Advice is provided to the driver (S15). The above-described steps are repeated, such that evaluation and advice about a driving operation of a driver are specifically provided to the driver. The driver attempts to reflect the evaluation and advice in a next driving operation.

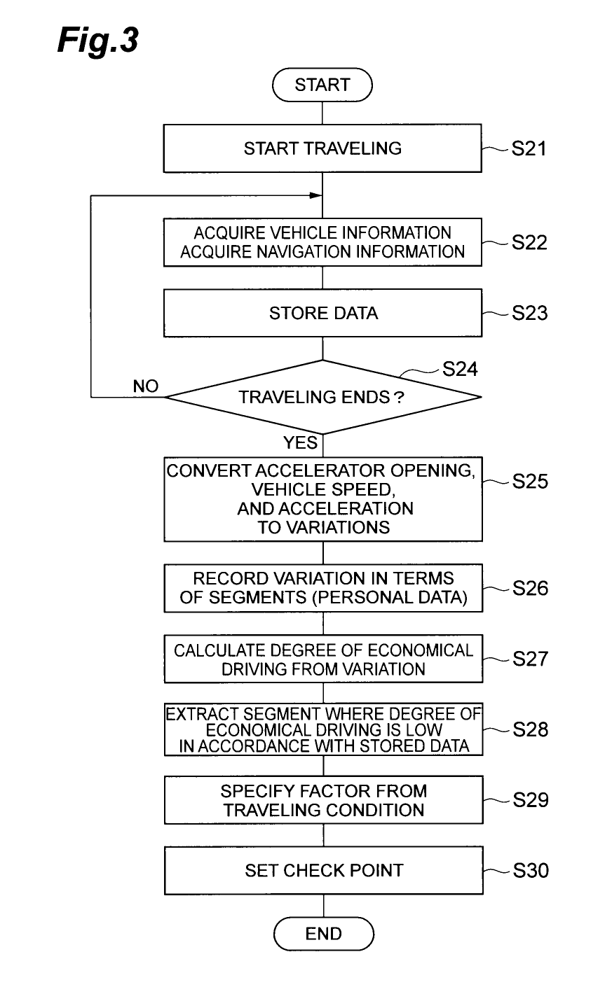

Hereinafter, an example of a feature extraction process for setting a check point will be described. As shown in FIG. 3, the host vehicle starts to travel (S21). While the host vehicle is traveling, the vehicle information Ia and the navigation information Ib are acquired by the data reception device 110 of the in-vehicle device 100 (S22). The acquired vehicle information Ia and navigation information Ib are aggregated by the data aggregation unit 121. Aggregated data is subjected to feature extraction in association with the traveling path, the road shape, the road inclination, the date, the day of week, the time, and the like of the navigation information Ib corresponding to when measuring the accelerator opening, the vehicle speed, the acceleration, and the like of the vehicle information Ia by the feature extraction unit 122. Data is stored in the personal data unit 123 (S23).

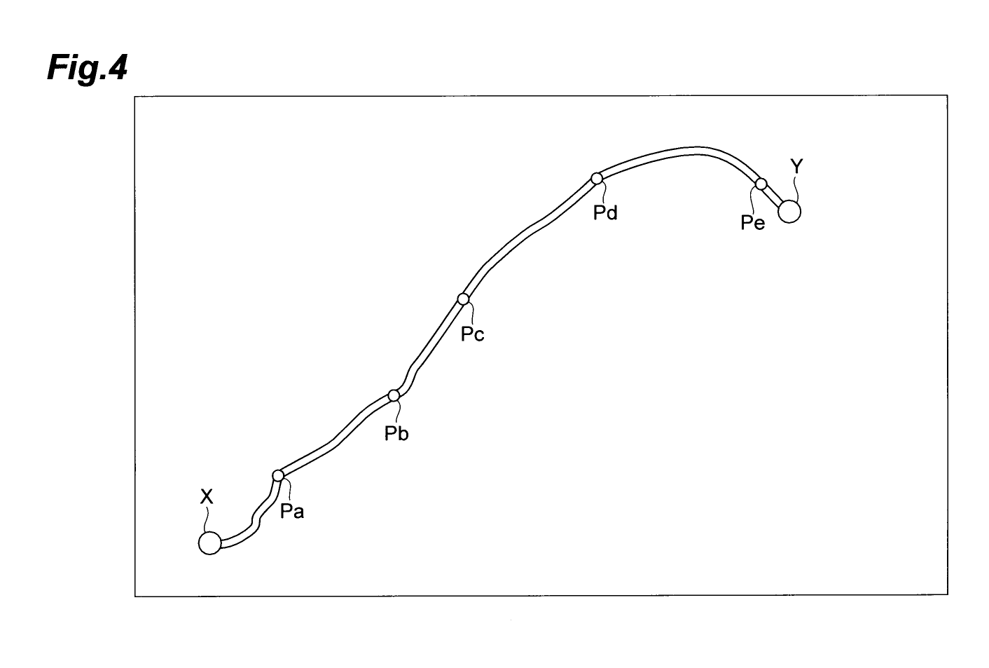

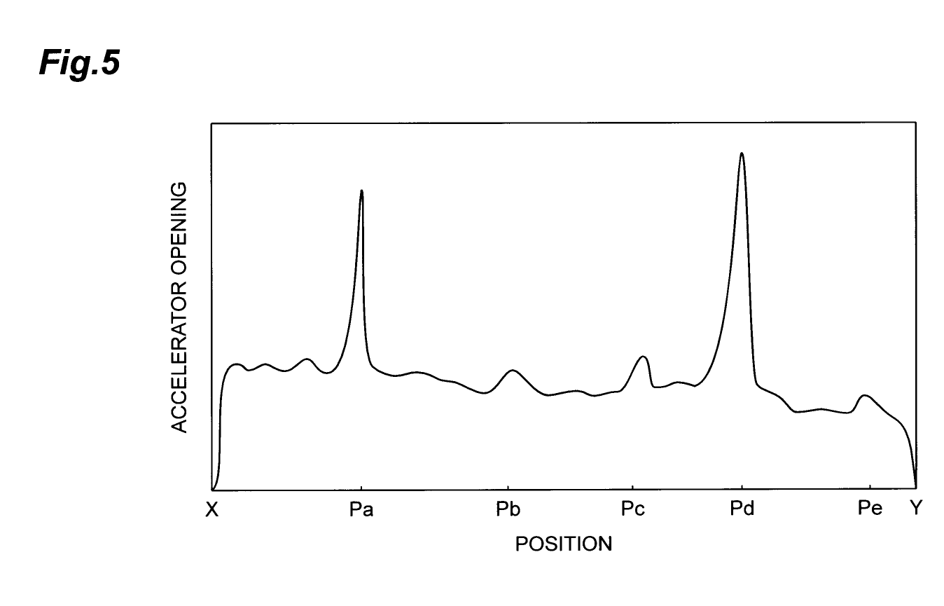

After traveling ends (S24), the feature extraction unit 122 converts the accelerator opening, the vehicle speed, and the acceleration to variations (S25). The feature extraction unit 122 allocates the variations in terms of segments of the traveling path, and records the variations in the personal data storage unit 131 of the recording device 130 (S26). For example, it is assumed that the host vehicle has traveled from a point X to a point Y shown in FIG. 4. In this case, the accelerator opening in each segment is as shown in FIG. 5. In the example shown in FIG. 5, from among points Pa to Pe between the points X and Y, a point where the accelerator opening is particularly high is the points Pa and Pd.

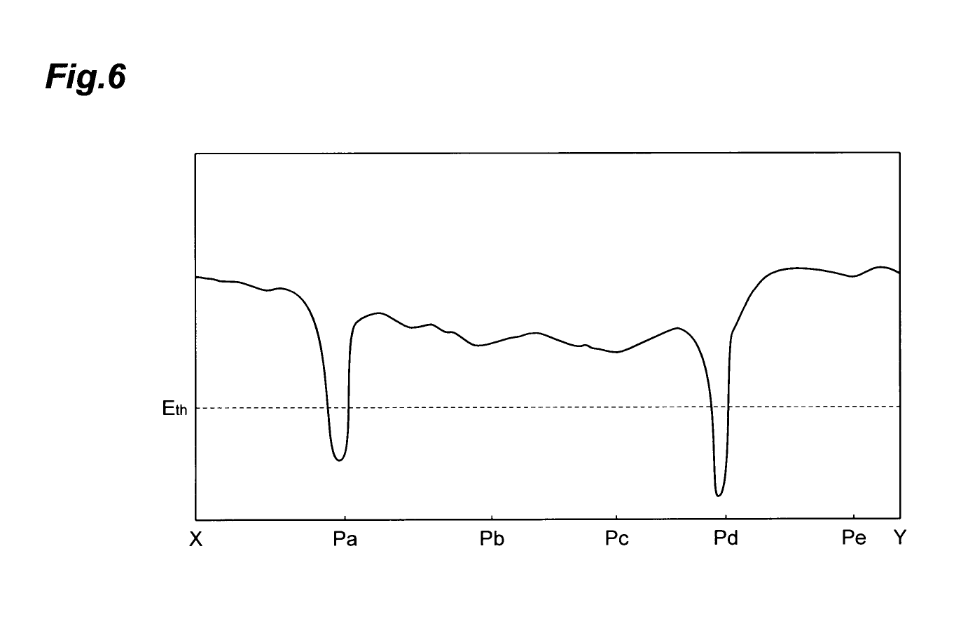

The check point calculation unit 132 of the recording device 130 calculates the degree of economical driving representing the degree of attainment of economical driving on the basis of the magnitude of the variation in the accelerator opening or the like (S27). The degree of economical driving can be calculated by quantifying the variations in the accelerator opening, the vehicle speed, the acceleration, and the like with the application of a predetermined weight. The check point calculation unit 132 extracts a point (segment) where the degree of economical driving is lower than a predetermined reference value in accordance with data stored in the personal data storage unit 131 (S28). For example, in the example of FIG. 6, the points Pa and Pd from among the points Pa to Pe between the points X and Y become a point where the degree of economical driving falls below a reference value Eth.

The check point calculation unit 132 estimates the influence of the road shape, the road inclination, the day of week, and the time zone from the traveling conditions of the extracted segment, and specifies a factor for a low degree of economical driving (S29). The traveling conditions as the factor for the low degree of economical driving are recorded in the personal data storage unit 131 separately from data in the segment. The check point calculation unit 132 sets a point where the degree of economical driving falls below the reference value Eth as a check point (S30). Information obtained in the above-described manner is transmitted to the information processing center 200 by the communication device 150 and recorded in the recording device 202.

Hereinafter, advice to a driver using a set check point will be described. It is assumed that the information processing center 200 performs the process shown in FIG. 3 along with an unspecified number of vehicles, and data regarding drivers of an unspecified number of vehicles is recorded in the recording device 202. The analysis device 203 analyzes a specific point where the degree of economical driving is low each time data regarding the unspecified number of drivers is acquired. The analysis device 203 records the analysis result in the recording device 202.

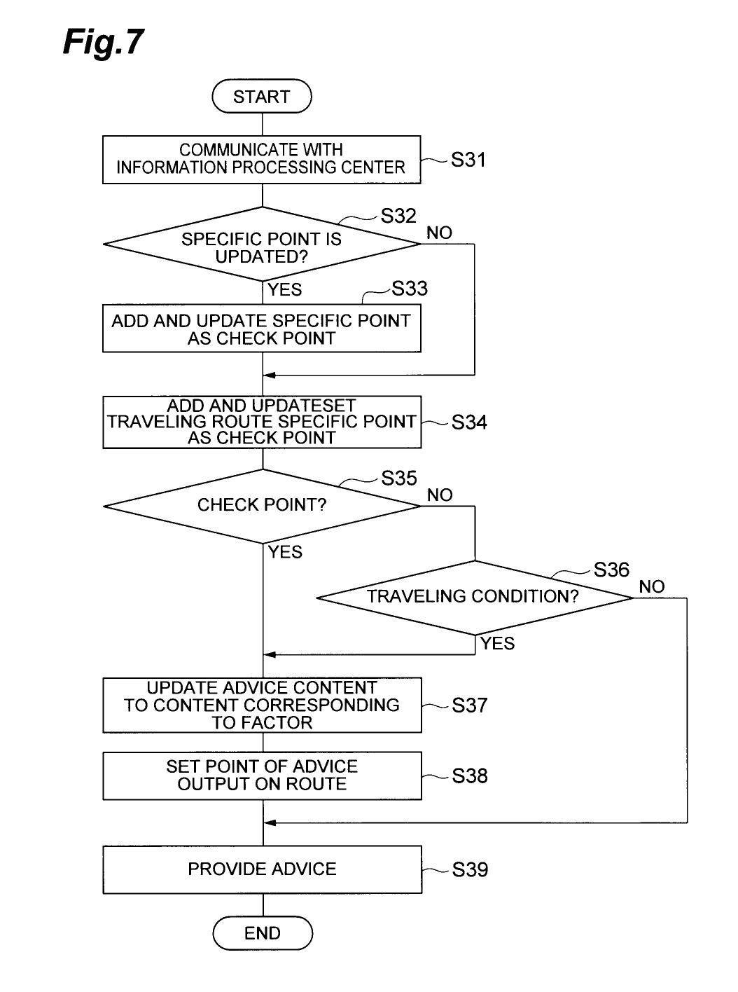

As shown in FIG. 7, the in-vehicle device 100 performs communication with the information processing center 200 (S31). If a specific point where the degree of economical driving is low is updated from data regarding the unspecified number of drivers obtained through communication with the information processing center 200 (S32), the check point calculation unit 132 of the in-vehicle device 100 adds the specific point as a check point (S33).

A traveling path is set on a navigation system (S34). For example, it is assumed that a path from the point X toward the point Y shown in FIG. 4 is set. When there is a check point on the traveling path (S35), the advice generation unit 124 of the control device 120 updates the content of advice for the driver to the content corresponding to the factor for the low degree of economical driving at the check point (S37).

Even if there is no check point on the traveling path (S35), when there is a segment on the traveling path where the traveling conditions are identical to the traveling conditions specified in the segment where the degree of economical driving is low (S36), the advice generation unit 124 of the control device 120 updates the content of advice for the driver to the content corresponding to the factor for the low degree of economical driving at the check point (S37). In this case, in regard to the difference in the traveling conditions, a predetermined weight is applied to the difference in the traveling path, the road shape, the road inclination, the date, the day of week, the time, and the like, and when the degree of difference is within a predetermined threshold value, it can be determined that the traveling conditions are identical.

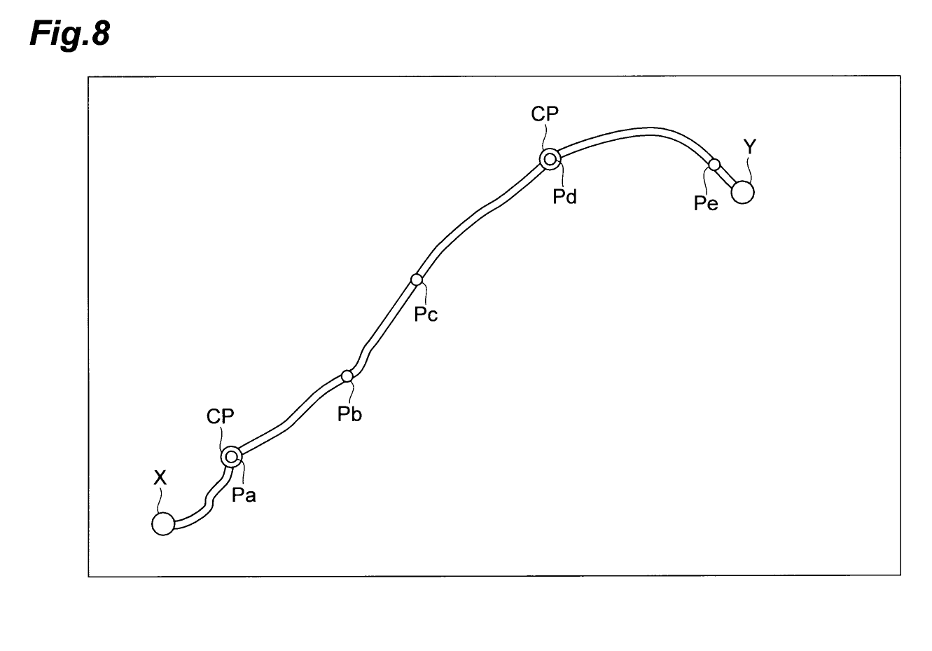

The advice generation unit 124 sets a point of advice output on the traveling path (S38). In this case, for example, as shown in FIG. 8, the points Pa and Pd which are check points CP blink, are popped, or are highlighted on a display screen, such as a display, with high brightness or the like.

The advice generation unit 124 provides advice to the driver of the host vehicle using the display device 140 for each check point CP (S39). For example, it is assumed that a check point is a road for slower traffic where the accelerator opening increases and mileage is lowered. It is assumed that the driving tendency of the driver of the host vehicle or an unspecified number of drivers is analyzed from data in which the tendency to increase the accelerator opening after the host vehicle has entered the road for slower traffic is stored. In this case, the advice generation unit 124 generates advice such that the accelerator opening increases to some extent before the host vehicle enters the road for slower traffic, the host vehicle enters the road for slower traffic after having increased in the vehicle speed, the accelerator opening as a whole decreases, and the degree of economical driving is equal to or greater than the reference value Eth.

Advice may be provided immediately before the host vehicle reaches the check point CP. Advice may also be provided before the host vehicle starts traveling in the traveling path or after the host vehicle has ended traveling in the traveling path. The driving support actuator 160 performs correction of the driving operation of the driver, such as switching between traveling by an internal-combustion engine and traveling by an electric motor, an increase in braking force, or correction of the shift position of a transmission, such that the degree of economical driving is equal to or greater than the reference value Eth.

According to this embodiment, the check point calculation unit 132 evaluates the driving of the driver of the host vehicle in a predetermined travel segment that the host vehicle has traveled, and extracts the check point CP in the travel segment where the driving evaluation does not meet a predetermined evaluation standard, thereby obtaining data representing a point in the travel segment where evaluation for a driving operation is lowered. The advice generation unit 124 supports the driving operation of the driver of the host vehicle on the basis of the check point CP extracted by the check point calculation unit 132, making it possible for the driver to improve driving focusing on a point in the travel segment where the driving evaluation is low. For this reason, it becomes easier for the driver to improve the driving operation based on the driving evaluation.

That is, in this embodiment, with the use of information extracted on the basis of the traveling conditions as the check point CP, it is possible to reduce a gap between the traveling result recognized by the driver between the driving evaluation by the system. The check point CP is set, thereby increasing the effect of advice. Advice is provided before the host vehicle enters the check point CP, thereby increasing the effect of advice. The check point CP is associated with the traveling conditions, such that a method for a driving operation which will be carried out by the driver becomes clear. The check point CP is fixed, and the driving operation is repeatedly carried out at the check point CP, such that the driving operation at the check point CP is easily learned. In this case, in another traveling path where there is a small difference in the traveling conditions, similarly, it is possible to expect the effect of improving the driving operation.

In this embodiment, where there is an estimated check point CP where the difference in the traveling conditions with respect to the check point CP is within a predetermined threshold value, the advice generation unit 124 supports the driving operation of the driver of the host vehicle on the basis of the estimated check point CP. For this reason, in regard to a point where the host vehicle has not yet actually traveled which is defined as the check point CP where the driving evaluation is likely to be lowered, it becomes possible for the driver to improve the driving operation.

In this embodiment, when there is a statistical check point CP where driving evaluation for drivers of an unspecified number of vehicles does not meet a predetermined evaluation standard, the advice generation unit 124 supports the driving operation of the driver of the host vehicle on the basis of the statistical check point CP. For this reason, in regard to a point where the host vehicle has actually traveled which is a point where driving evaluation for an unspecified number of drivers is low and is thus defined as a point where more attention is paid to the driving operation, it becomes possible for the driver to improve the driving operation. Alternatively, in regard to a point where the host vehicle has not yet actually traveled which is a point where driving evaluation for the unspecified number of drivers is low and is thus defined as the check point CP where the driving evaluation for the driver is likely to be lowered, it becomes possible for the driver to improve the driving operation.

According to this embodiment, when there is the check point CP in the traveling direction of the host vehicle, the advice generation unit 124 supports the driving operation of the driver of the host vehicle such that the driving evaluation by the check point calculation unit 132 meets the predetermined evaluation standard at the check point CP. Thus, it becomes possible to improve the driving evaluation at the check point CP where the driving evaluation is low and to improve the driving evaluation as a whole.

According to this embodiment, the display device 140 highlights the check point CP on the display screen to support the driving operation of the driver of the host vehicle. For this reason, it becomes easy for the driver to visually recognize the check point CP.

According to this embodiment, the driving support actuator 160 performs traveling control for correcting the driving operation of the driver of the host vehicle to support the driving operation of the driver of the host vehicle. For this reason, even if the driving operation of the driver of the host vehicle is not appropriate, it becomes possible to improve the driving evaluation.

The communication device 201 of the information processing center 200 distributes information including the check point CP to the vehicles, making it easy for the vehicles to use information including the check point CP.

Although an embodiment of the invention has been described, the invention is not limited to the foregoing embodiment, and various modifications may be made. For example, although in the foregoing embodiment, the exchange of information, such as the check point CP or the traveling conditions, between the in-vehicle device 100 and the information processing center 200 is done through wireless communication using the communication devices 150 and 201, in the invention, the exchange of information may be done when the driver attaches a removable medium, such as a flexible disk, a magneto-optical disc, a CD-R, a flash memory, a USB memory, or a removable hard disk, to a terminal which is connectable to the information processing center 200.

In the foregoing embodiment, the components in the in-vehicle device 100 and the information processing center 200 may be provided in either the in-vehicle device 100 or the information processing center 200. For example, the data reception device 110, the display device 140, the driving support actuator 160, and the communication device 150 may be mounted only in the in-vehicle device 100, and all other components may be provided in the information processing center 200. Alternatively, a form in which all the components of the driving evaluation system 10 may be provided only in the in-vehicle device 100 without using the information processing center 200 also falls within the scope of the invention.

### INDUSTRIAL APPLICABILITY

According to the in-vehicle device, the information processing center, and the driving evaluation system of the invention, it becomes easier for the driver to improve a driving operation based on driving evaluation.

### REFERENCE SIGNS LIST

10: driving evaluation system

100: in-vehicle device

110: data reception device

120: control device

121: data aggregation unit

122: feature extraction unit

123: personal data unit

124: advice generation unit

130: recording device

131: personal data storage unit

132: check point calculation unit

140: display device

150: communication device

160: driving support actuator

200: information processing center

201: communication device

202: recording device

203: analysis device

1-17. (canceled)

18. An in-vehicle device comprising:
an evaluation unit which evaluates the driving of a driver of a host vehicle in a predetermined travel segment that the host vehicle has traveled; and
a driving support unit which supports a driving operation of the driver of the host vehicle at a caution point in the travel segment where the driving evaluation by the evaluation unit does not meet a predetermined evaluation standard,
wherein, when there is the caution point in the traveling direction of the host vehicle, the driving support unit supports the driving operation of the driver of the host vehicle such that the driving evaluation by the evaluation unit meets the predetermined evaluation standard at the caution point.

19. The in-vehicle device according to claim 18,
wherein, when there is an estimated caution point where the difference in traveling conditions with respect to the caution point is within a predetermined threshold value, the driving support unit supports the driving operation of the driver of the host vehicle on the basis of the estimated caution point.

20. An in-vehicle device comprising:
an evaluation unit which evaluates the driving of a driver of a host vehicle in a predetermined travel segment that the host vehicle has traveled;
a driving support unit which supports a driving operation of the driver of the host vehicle at a caution point in the travel segment where the driving evaluation by the evaluation unit does not meet a predetermined evaluation standard,
wherein, when there is an estimated caution point where the difference in traveling conditions with respect to the caution point is within a predetermined threshold value, the driving support unit supports the driving operation of the driver of the host vehicle on the basis of the estimated caution point.

21. The in-vehicle device according to claim 20,
wherein, when there is the caution point in the traveling direction of the host vehicle, the driving support unit supports the driving operation of the driver of the host vehicle such that the driving evaluation by the evaluation unit meets the predetermined evaluation standard at the caution point.

22. The in-vehicle device according to claim 18,
wherein, when there is a statistical caution point where driving evaluation for drivers of an unspecified number of other vehicles does not meet the predetermined evaluation standard, the driving support unit supports the driving operation of the driver of the host vehicle on the basis of the statistical caution point.

23. The in-vehicle device according to claim 20,
wherein, when there is a statistical caution point where driving evaluation for drivers of an unspecified number of other vehicles does not meet the predetermined evaluation standard, the driving support unit supports the driving operation of the driver of the host vehicle on the basis of the statistical caution point.

24. The in-vehicle device according to claim 18,
wherein the driving support unit highlights the caution point on a display screen to support the driving operation of the driver of the host vehicle.

25. The in-vehicle device according to claim 20,
wherein the driving support unit highlights the caution point on a display screen to support the driving operation of the driver of the host vehicle.

26. The in-vehicle device according to claim 18,
wherein the driving support unit performs traveling control for correcting the driving operation of the driver of the host vehicle to support the driving operation of the driver of the host vehicle.

27. The in-vehicle device according to claim 20,
wherein the driving support unit performs traveling control for correcting the driving operation of the driver of the host vehicle to support the driving operation of the driver of the host vehicle.

28. An information processing center comprising:
an evaluation unit which evaluates the driving of a driver of one host vehicle in a predetermined travel segment that one vehicle has traveled; and
a caution point extraction unit which extracts a caution point in the travel segment where the driving evaluation by the evaluation unit does not meet a predetermined evaluation standard,
wherein the caution point extraction unit extracts a point where the difference in traveling conditions with respect to the caution point is within a predetermined threshold value as an estimated caution point.

29. The information processing center according to claim 28,
wherein the evaluation unit evaluates the driving of drivers of an unspecified number of other vehicles in a predetermined travel segment that the unspecified number of other vehicles have traveled, and
the caution point extraction unit extracts a point where the driving evaluation by the evaluation unit does not meet a predetermined evaluation standard as a statistical caution point.

30. The information processing center according to claim 28, further comprising:
a distribution unit which distributes information including the caution point to the one vehicle.

31. A driving evaluation system comprising:
an evaluation unit which evaluates the driving of a driver of one vehicle in a predetermined travel segment that the one vehicle has traveled; and
a driving support unit which supports a driving operation of the driver of the one vehicle at a caution point in the travel segment where the driving evaluation by the evaluation unit does not meet a predetermined evaluation standard,
wherein, when there is the caution point in the traveling direction of the one vehicle, the driving support unit supports the driving operation of the driver of the one vehicle such that the driving evaluation by the evaluation unit meets the predetermined evaluation standard at the caution point.

32. The driving evaluation system according to claim 31,
wherein, when there is an estimated caution point where the difference in traveling conditions with respect to the caution point is within a predetermined threshold value, the driving support unit supports the driving operation of the driver of the one vehicle on the basis of the estimated caution point.

33. A driving evaluation system comprising:
an evaluation unit which evaluates the driving of a driver of one vehicle in a predetermined travel segment that the one vehicle has traveled; and
a driving support unit which supports a driving operation of the driver of the one vehicle at a caution point in the travel segment where the driving evaluation by the evaluation unit does not meet a predetermined evaluation standard,
wherein, when there is an estimated caution point where the difference in traveling conditions with respect to the caution point is within a predetermined threshold value, the driving support unit supports the driving operation of the driver of the one vehicle on the basis of the estimated caution point.

34. The driving evaluation system according to claim 33,
wherein, when there is the caution point in the traveling direction of the one vehicle, the driving support unit supports the driving operation of the driver of the one vehicle such that the driving evaluation by the evaluation unit meets the predetermined evaluation standard at the caution point.

35. The driving evaluation system according to claim 31,
wherein the evaluation unit evaluates the driving of drivers of unspecified number of other vehicles in a predetermined travel segment that the unspecified number of other vehicles have traveled, and
the driving support unit supports the driving operation of the driver of the one vehicle on the basis of a statistical caution point where the driving evaluation by the evaluation unit does not meet a predetermined evaluation standard.

36. The driving evaluation system according to claim 33,
wherein the evaluation unit evaluates the driving of drivers of unspecified number of other vehicles in a predetermined travel segment that the unspecified number of other vehicles have traveled, and
the driving support unit supports the driving operation of the driver of the one vehicle on the basis of a statistical caution point where the driving evaluation by the evaluation unit does not meet a predetermined evaluation standard.

37. The driving evaluation system according to claim 31,
wherein, when there is the caution point in the traveling direction of the one vehicle, the driving support unit supports the driving operation of the driver of the one vehicle such that the driving evaluation by the evaluation unit meets the predetermined evaluation standard at the caution point.

38. The driving evaluation system according to claim 33,
wherein, when there is the caution point in the traveling direction of the one vehicle, the driving support unit supports the driving operation of the driver of the one vehicle such that the driving evaluation by the evaluation unit meets the predetermined evaluation standard at the caution point.

39. The driving evaluation system according to claim 31,
wherein the driving support unit highlights the caution point on a display screen to support the driving operation of the driver of the one vehicle.

40. The driving evaluation system according to claim 33,
wherein the driving support unit highlights the caution point on a display screen to support the driving operation of the driver of the one vehicle.
